(19) United States
(12) Patent Application Publication
(10) Pub. No.: US 2022/0027156 A1
(43) Pub. Date: Jan. 27, 2022

(54) PERFORMANCE OPTIMIZATION OF CLOSE CODE

(71) Applicants: Andrew Ward Beale, Irvine, CA (US); David Strong, Irvine, CA (US)

(72) Inventors: Andrew Ward Beale, Irvine, CA (US); David Strong, Irvine, CA (US)

(73) Assignee: Unisys Corporation, Blue Bell, PA (US)

(21) Appl. No.: 16/934,247

(22) Filed: Jul. 21, 2020

(51) Int. Cl. G06F 9/30; G06F 9/455; G06F 9/38

(52) U.S. Cl. CPC G06F 9/30054; G06F 9/3806; G06F 9/45508

(57) ABSTRACT

Methods and systems described herein utilize a jump table in directly-addressable, near code, to facilitate improved execution of frequent calls to executable code from other workloads outside of the near code. By executing a directly-addressable call and jump instruction to access frequently-accessed executable code, indirect call instructions are avoided.

### BACKGROUND

When executable code is compiled for execution on a target computing platform, typically a location of the origin (e.g., starting address) of that code may be designated. In most cases, the code may simply be compiled and loaded into memory for execution without too much regard for the location of that executable code.

In some instances, the location of particular portions of code relative to the starting point of execution may become important. For example, code that is frequently executed together will typically be maintained in contiguous memory locations to avoid possible inefficiencies relating to computation of instruction pointers, or potential cache misses.

In the case of emulated code, an emulator executable may perform a core set of functions, for example to fetch and decode non-native instructions in hosted code, identify a set of one or more native instructions that can emulate execution of the non-native instructions, and otherwise monitor and manage system state. That core executable will operate by generally accessing a next non-native instruction, decoding that instruction to determine the non-native operation to be performed, and the performing an equivalent function using a native instruction set architecture.

In such an emulated execution context, non-native code is typically accessed, followed by access of the emulator executable to perform an emulated version of the non-native code. Following execution of that native code, a subsequent non-native instructions may be accessed, resulting in a subsequent call to the emulator executable. In other words, due to emulation, memory accesses will sequence between the location of emulated code and the location of the emulator executable. In such a context, calls between those code segments are executed frequently.

In some existing instruction set architectures, a call instruction may be used to make a call to the emulator executable, since a call instruction can include a direct offset from the starting location of the code, and is therefore relatively efficient. This is because (1) the offset is included in the instruction rather than being stored in a register to be retrieved, or requiring calculation, and (2) no conditional processing is required, thereby allowing pipelined processors to accurately pre-fetch instructions at the target of the call instruction, thereby maintaining a full pipeline of instructions.

However, use of such call instructions has limitations. For example, in the Intel 64-bit x86-based instruction set architecture, a call instruction can reference a direct address using a 32-bit address offset, sign extended. This means that such a call instruction may be used to access code segments that are within a 4 gigabyte (GB) addressable space (e.g., 2 GB in either direction from a starting address). Such a boundary may be considered the outer bounds of “near” code that can be directly accessed, or called. While a full 64-bit address may be used in other call instructions, typically such call instructions are based on indirect addressing schemes which may introduce conditionality and further delay in terms of address calculation.

This limitation of the direct call instruction available in existing instruction set architectures is typically not a significant problem since modern compilers tend to place code near other code that will be called, and because such calls happen comparatively infrequently in code. However, in the context of the emulated executable described above, the performance degradation can become significant if code is placed outside of this “near” code area, because the frequency of such calls, and attendant address calculation and/or processor pipeline inefficiencies, may lead to significant performance degradation. As executables become larger and more complex, the availability of “near” memory space becomes at a greater premium. Accordingly, improvements in managing memory addressing to reduce computational overhead with respect to frequently-called code segments are desirable to improve overall system performance.

### SUMMARY

In general, the present disclosure relates to implementing a jump table in directly-addressable, near code, to facilitate improved execution of frequent calls to executable code from other workloads outside of the near code. By executing a directly-addressable call and jump instruction, indirect call instructions are avoided, thereby reducing processing inefficiencies inherent in such instructions.

In a first aspect, a method includes instantiating executable code in a memory of a computing system, the executable code having a starting location in the memory. The method further includes implementing, within a near code area within the memory relative to the executable code, a jump table at a memory location proximate to a boundary of directly-addressable memory in the near code, the jump table including a plurality of entries each associated with one of a plurality of functions included in the executable code. The method also includes, upon executing a call to one of the plurality of functions in the executable code from a workload: executing a call instruction into the jump table from the workload, the call instruction including a direct address to a location in the jump table; and executing the direct jump instruction from the jump table into the function.

In a second aspect, a method of executing a hosted workload executable according to a non-native instruction set architecture on a computing system having a memory and a processor implemented using a native instruction set architecture is disclosed. The method includes instantiating a core emulation executable at a location in memory of the computing system, the core emulation executable including a plurality of functions. The method further includes placing a jump table in memory at a location from which the core emulation executable may be reached via a direct jump instruction in the native instruction set architecture, each of a plurality of entries in the jump table including a direct jump instruction to a different one of the plurality of functions. The method also includes executing a hosted workload from the memory of the computing system, the hosted workload being located, at least in part, in code outside of a region in memory from which the core emulation executable may be reached via a direct call instruction. The method includes, upon executing a call from the workload to a function included in the plurality of functions of the core emulation executable: performing a directly-addressable call instruction to access the jump table; and performing a direct jump instruction from the jump table to a function within the core emulation executable.

In a third aspect, a computing system includes a processor capable of executing instructions according to a native instruction set architecture and a memory communicatively connected to the processor. The memory stores instructions which, when executed by the processor, cause the computing system to perform: instantiating a core emulation executable at a location in memory of the computing system, the core emulation executable including a plurality of functions; placing a jump table in memory at a location from which the core emulation executable may be reached via a direct jump instruction in the native instruction set architecture, each of a plurality of entries in the jump table including a direct jump instruction to a different one of the plurality of functions; executing a hosted workload from the memory of the computing system, the hosted workload located at least in part in code outside of a region in memory from which the core emulation executable may be reached via a direct call instruction; and, upon executing a call from the workload to a function included in the plurality of functions of the core emulation executable: performing a directly-addressable call instruction to access the jump table; and performing a direct jump instruction from the jump table to the function within the core emulation executable.

### BRIEF DESCRIPTION OF THE DRAWINGS

The same number represents the same element or same type of element in all drawings.

FIG. 1 is a schematic illustration of an example computing system useable as a host computing system in which aspects of the present disclosure can be implemented.

FIG. 2 illustrates a distributed multi-host system in which aspects of the present disclosure can be implemented.

FIG. 3 is a schematic illustration of an example computing system in which aspects of the present disclosure can be implemented.

FIG. 4 is a flowchart of a method of executing a hosted workload according to principles of the present disclosure, according to example embodiments.

FIG. 5 is a schematic depiction of an address space of a host computing system implemented using methods and systems described herein.

FIG. 6 is a schematic depiction of instantiation of jump tables within the address space of FIG. 5.

FIG. 7 is a schematic depiction of an example jump table useable to implement aspects of the present disclosure.

FIG. 8 is a schematic depiction of a second example jump table useable to implement aspects of the present disclosure.

FIG. 9 is a flowchart of a method of ordering a jump table, according to an example embodiment.

FIG. 10 is a schematic depiction of reordering of a jump table, according to the method of FIG. 9.

### DETAILED DESCRIPTION

As briefly described above, embodiments of the present invention are directed to implementing a jump table in directly-addressable, near code, to facilitate improved execution of frequent calls to executable code from other workloads outside of the near code. By executing a directly-addressable call and jump instruction, indirect call instructions are avoided, thereby reducing processing inefficiencies inherent in such instructions.

Generally, and by way of background, it is recognized that although CPU stalls occur regularly during execution of instructions, it is desirable that such stalls are minimized to ensure that the performance advantages of pipelined processor technologies are realized. In other words, in the event of significant numbers of indirect calls and/or incorrectly-predicted branch instructions, CPU inefficiencies increase greatly. Accordingly, when executing a workload that includes a high frequency of call instructions, it is desirable to have those call instructions be implemented using a direct call, which utilizes an address within the instruction itself. However, as workload code sizes increase, it may not be possible to include all of a workload within an addressable range of a direct call instruction. As noted above, a 32-bit address used in a call instruction may only allow for a 4 gigabyte (GB) addressable range, and therefore any workload code including such calls would need to fit within the 4 GB space surrounding the code to be called.

In accordance with the present disclosure, installing code within memory locations outside of these “near” address range locations may nevertheless avoid a performance degradation that would otherwise be experienced if indirect or conditional call instructions were utilized. Rather, an additional address range is implemented, referred to herein as a “close” address range. The close address range represents an address range that may be reached via two directly-addressed call or jump instructions. In other words, and as described herein, a further address range outside of the “near” address range but adjacent thereto may be implemented. In example embodiments, the “close” address range may be a similarly addressable range having a size dependent on the native instruction set architecture of the computing system on which it is implemented. For example, as in the above circumstance where a near address range allows for +/−2 GB addressing (a total of 4 GB of addressable space), the “close” address range can extend this by an additional 2 GB in each direction from the outer bound of the near address range. Use of two unconditional call or jump instructions (one from the close address range to the near address range, and one from the near address range to the code being called) may provide an execution efficiency as compared to use of indirect call or jump instructions in such cases.

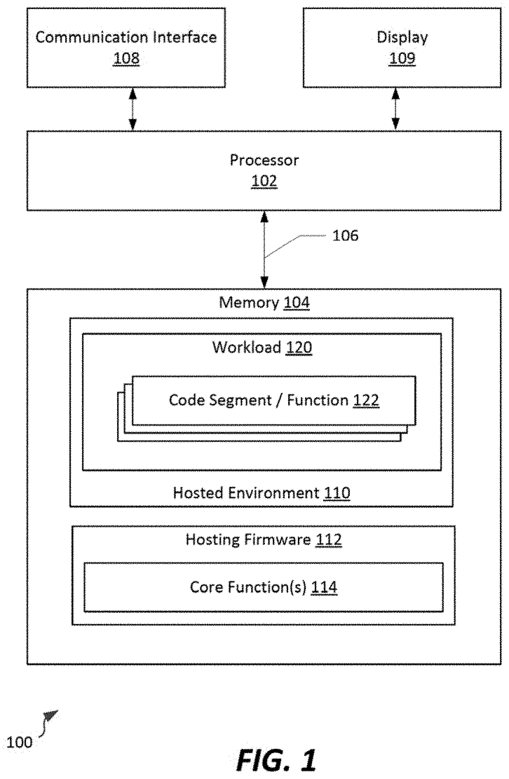

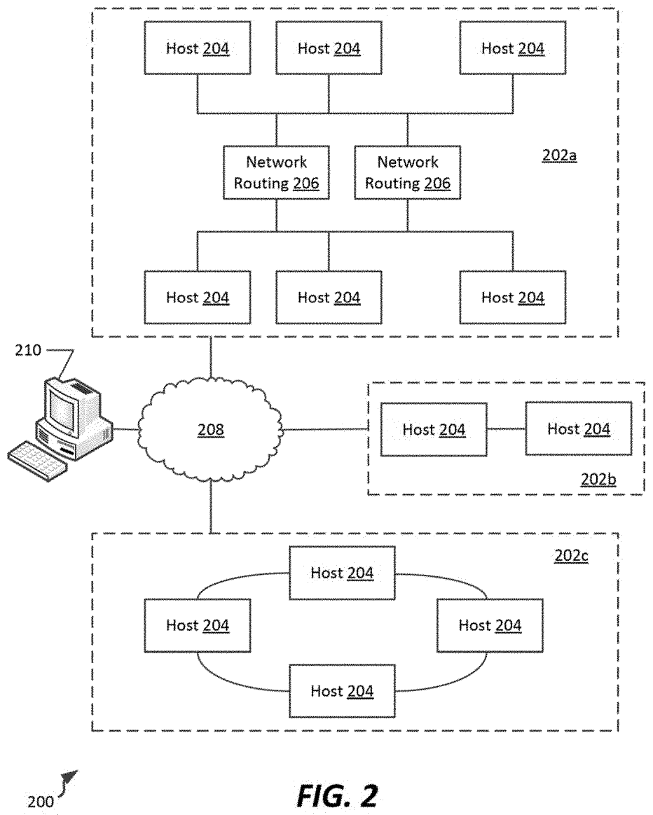

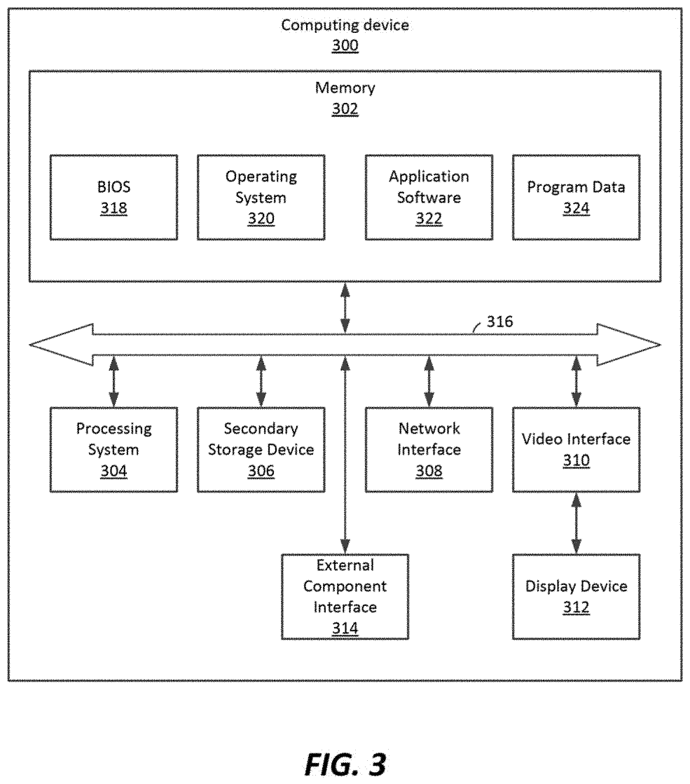

Referring to FIG. 1, an example computing system 100 is shown in which aspects of the present disclosure may be implemented is shown. In the example shown, a computing computing system 100 comprises a host system. The computing system 100 can, for example, be a commodity computing system including one or more computing devices, such as the computing system described in conjunction with FIGS. 2-3. The computing system 100 may, for example, execute utilizing a particular instruction set architecture and operate in system, such as a x86 or ARM-based instruction set architecture and a Windows-based operating system provided by Microsoft corporation of Redmond Wash..

In general, the computing system 100 includes a processor 102 communicatively connected to a memory 104 via a data bus 106. The processor 102 can be any of a variety of types of programmable circuits capable of executing computer-readable instructions to perform various tasks, such as mathematical and communication tasks, such as those described below in connection with FIGS. 2-3.

The memory 104 can include any of a variety of memory devices, such as using various types of computer-readable or computer storage media, as also discussed below. In the embodiment shown, the memory 104 stores instructions which, when executed, provide a hosted environment 110 and hosting firmware 112, discussed in further detail below. The computing system 100 can also include a communication interface 108 configured to receive and transmit data, e.g., to provide access to a sharable resource such as a resource hosted by the hosted environment 110. Additionally, a display 109 can be used for viewing a local version of a user interface, e.g., to view executing tasks on the computing system 100 and/or within the hosted environment 110.

In example embodiments, the hosted environment 110 is executable from memory 104 via a processor 102 based on execution of hosting firmware 112. Generally, the hosting firmware 112 translates instructions stored in the hosted environment 110 for execution from an instruction set architecture of the hosted environment 110 to a native instruction set architecture of the host computing environment, i.e., the instruction set architecture of the processor 102. In a particular embodiment, the hosting firmware 112 translates instructions from a hosted MCP environment to a host Windows-based (e.g., x86-based) environment.

In the example shown, the hosted environment 110 includes at least one workload 120. The workload 120 may be any application or executable program that may be executed according to an instruction set architecture, and based on a hosted platform, of a computing system other than the computing system 100. Accordingly, the workload 120, through operation within the hosted environment 110 and execution of the hosting firmware 112, may execute on the computing system 100.

In example embodiments, the workload 120 corresponds to applications that are executable within the hosted environment 110. For example, the workload 120 may be written in any language, or compiled in an instruction set architecture, which is compatible with execution within the hosted environment 110.

Although the system 100 reflects a particular configuration of computing resources, it is recognized that the present disclosure is not so limited. In particular, access to sharable resources may be provided from any of a variety of types of computing environments, rather than solely a hosted, non-native environment. The methods described below may provide secure access to such sharable resources in other types of environments. Still further, additional details regarding an example computing system implemented according to aspects of the present disclosure are provided in U.S. patent application Ser. No. 16/782,875, entitled “ONE-TIME PASSWORD FOR SECURE SHARE MAPPING”, the disclosure of which is hereby incorporated by reference in its entirety.

Referring now to FIGS. 2-3, example hardware environments are disclosed in which aspects of the present disclosure may be implemented. The hardware environments disclose may, for example, represent particular computing systems or computing environments useable within the overall context of the system described above in conjunction with FIG. 1.

Referring now to FIG. 2, a distributed multi-host system 200 is shown in which aspects of the present disclosure can be implemented. The system 200 represents a possible arrangement of computing systems or virtual computing systems useable to implement the computing system 100 of FIG. 1; in other words, the computing system 100 may be a distributed system hosted across a plurality of physical computing devices. In the embodiment shown, the system 200 is distributed across one or more locations 202, shown as locations 202a-c. These can correspond to locations remote from each other, such as a data center owned or controlled by an organization, a third-party managed computing cluster used in a “cloud” computing arrangement, or other local or remote computing resources residing within a trusted grouping. In the embodiment shown, the locations 202a-c each include one or more host systems 204, or nodes. The host systems 204 represent host computing systems, and can take any of a number of forms. For example, the host systems 204 can be server computing systems having one or more processing cores and memory subsystems and are useable for large-scale computing tasks. In one example embodiment, a host system 204 can be as illustrated in FIG. 3.

As illustrated in FIG. 2, a location 202 within the system 200 can be organized in a variety of ways. In the embodiment shown, a first location 202a includes network routing equipment 206, which routes communication traffic among the various hosts 204, for example in a switched network configuration. Second location 202b illustrates a peer-to-peer arrangement of host systems. Third location 202c illustrates a ring arrangement in which messages and/or data can be passed among the host computing systems themselves, which provide the routing of messages. Other types of networked arrangements could be used as well.

In various embodiments, at each location 202, the host systems 204 are interconnected by a high-speed, high-bandwidth interconnect, thereby minimizing latency due to data transfers between host systems. In an example embodiment, the interconnect can be provided by an IP-based network; in alternative embodiments, other types of interconnect technologies, such as an Infiniband switched fabric communications link, Fibre Channel, PCI Express, Serial ATA, or other interconnect could be used as well.

Among the locations 202a-c, a variety of communication technologies can also be used to provide communicative connections of host systems 204 at different locations. For example, a packet-switched networking arrangement, such as via the Internet 208, could be used. Preferably, the interconnections among locations 202a-c are provided on a high-bandwidth connection, such as a fiber optic communication connection.

In the embodiment shown, the various host systems 204 at locations 202a-c can be accessed by a client computing system 210. The client computing system can be any of a variety of desktop or mobile computing systems, such as a desktop, laptop, tablet, smartphone, or other type of user computing system. In alternative embodiments, the client computing system 210 can correspond to a server not forming a cooperative part of the para-virtualization system described herein, but rather which accesses data hosted on such a system. It is of course noted that various virtualized partitions within a para-virtualization system could also host applications accessible to a user and correspond to client systems as well.

It is noted that, in various embodiments, different arrangements of host systems 204 within the overall system 200 can be used; for example, different host systems 204 may have different numbers or types of processing cores, and different capacity and type of memory and/or caching subsystems could be implemented in different ones of the host system 204. Furthermore, one or more different types of communicative interconnect technologies might be used in the different locations 202a-c, or within a particular location.

Referring now to FIG. 3, a schematic illustration of an example discrete computing system in which aspects of the present disclosure can be implemented. The computing device 300 can represent, for example, a native computing system, such as computing system 100. In particular, the computing device 300 represents the physical construct of an example computing system at which an endpoint or server could be established. In some embodiments, the computing device 300 implements virtualized or hosted systems, and executes one particular instruction set architecture while being used to execute non-native software and/or translate non-native code streams in an adaptive manner, for execution in accordance with the methods and systems described herein.

In the example of FIG. 3, the computing device 300 includes a memory 302, a processing system 304, a secondary storage device 306, a network interface card 308, a video interface 310, a display unit 312, an external component interface 314, and a communication medium 316. The memory 302 includes one or more computer storage media capable of storing data and/or instructions. In different embodiments, the memory 302 is implemented in different ways. For example, the memory 302 can be implemented using various types of computer storage media.

The processing system 304 includes one or more processing units. A processing unit is a physical device or article of manufacture comprising one or more integrated circuits that selectively execute software instructions. In various embodiments, the processing system 304 is implemented in various ways. For example, the processing system 304 can be implemented as one or more physical or logical processing cores. In another example, the processing system 304 can include one or more separate microprocessors. In yet another example embodiment, the processing system 304 can include an application-specific integrated circuit (ASIC) that provides specific functionality. In yet another example, the processing system 304 provides specific functionality by using an ASIC and by executing computer-executable instructions.

The secondary storage device 306 includes one or more computer storage media. The secondary storage device 306 stores data and software instructions not directly accessible by the processing system 304. In other words, the processing system 304 performs an I/O operation to retrieve data and/or software instructions from the secondary storage device 306. In various embodiments, the secondary storage device 306 includes various types of computer storage media. For example, the secondary storage device 306 can include one or more magnetic disks, magnetic tape drives, optical discs, solid state memory devices, and/or other types of computer storage media.

The network interface card 308 enables the computing device 300 to send data to and receive data from a communication network. In different embodiments, the network interface card 308 is implemented in different ways. For example, the network interface card 308 can be implemented as an Ethernet interface, a token-ring network interface, a fiber optic network interface, a wireless network interface (e.g., WiFi, WiMax, etc.), or another type of network interface.

The video interface 310 enables the computing device 300 to output video information to the display unit 312. The display unit 312 can be various types of devices for displaying video information, such as an LCD display panel, a plasma screen display panel, a touch-sensitive display panel, an LED screen, a cathode-ray tube display, or a projector. The video interface 310 can communicate with the display unit 312 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 314 enables the computing device 300 to communicate with external devices. For example, the external component interface 314 can be a USB interface, a FireWire interface, a serial port interface, a parallel port interface, a PS/2 interface, and/or another type of interface that enables the computing device 300 to communicate with external devices. In various embodiments, the external component interface 314 enables the computing device 300 to communicate with various external components, such as external storage devices, input devices, speakers, modems, media player docks, other computing devices, scanners, digital cameras, and fingerprint readers.

The communication medium 316 facilitates communication among the hardware components of the computing device 300. In the example of FIG. 3, the communications medium 316 facilitates communication among the memory 302, the processing system 304, the secondary storage device 306, the network interface card 308, the video interface 310, and the external component interface 314. The communications medium 316 can be implemented in various ways. For example, the communications medium 316 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

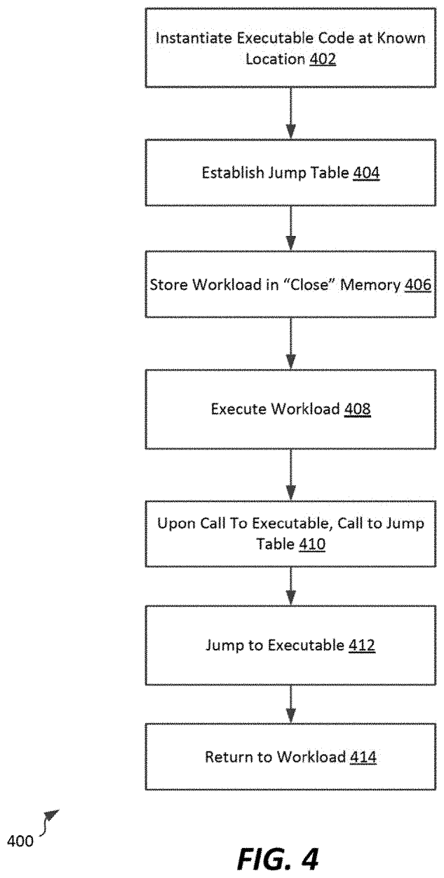

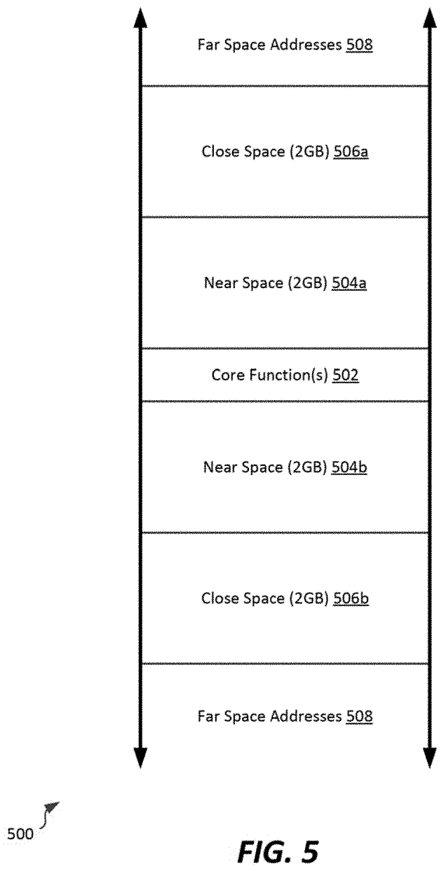

The memory 302 stores various types of data and/or software instructions. For instance, in the example of FIG. 3, the memory 302 stores a Basic Input/Output System (BIOS) 318 and an operating system 320. The BIOS 318 includes a set of computer-executable instructions that, when executed by the processing system 304, cause the computing device 300 to boot up. The operating system 320 includes a set of computer-executable instructions that, when executed by the processing system 304, cause the computing device 300 to provide an operating system that coordinates the activities and sharing of resources of the computing device 300. Furthermore, the memory 302 stores application software 322. The application software 322 includes computer-executable instructions, that when executed by the processing system 304, cause the computing device 300 to provide one or more applications. The memory 302 also stores program data 324. The program data 324 is data used by programs that execute on the computing device 300. Example program data and application software is described below in connection with FIGS. 4-5.

Although particular features are discussed herein as included within a computing device 300, it is recognized that in certain embodiments not all such components or features may be included within a computing device executing according to the methods and systems of the present disclosure. Furthermore, different types of hardware and/or software systems could be incorporated into such an electronic computing device.

In accordance with the present disclosure, the term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal.

By way of example, and not limitation, communication media may include wired media such as a wired network or direct-wired connection, and wireless media such as acoustic, radio frequency (RF), infrared, and other wireless media. Computer storage media does not include a carrier wave or other propagated or modulated data signal. In some embodiments, the computer storage media includes at least some tangible features; in many embodiments, the computer storage media includes entirely non-transitory components.

Referring now to FIG. 4, a flowchart of an example method 400 is shown for executing a hosted workload, according to example embodiments discussed herein. The method 400 can be performed, for example, on any computing system such as those described above in connection with FIGS. 1-3. In example embodiments, the method 400 may be used to improve overall processing performance of a computing system that would otherwise be forced to execute indirect calls frequently. The method 400 may be particularly advantageous when used in situations where frequent calls into a code segment are made, for example in a hosting environment where frequent calls to a hosting executable are made.

In the embodiment shown, the method 400 includes instantiating executable code at a known memory location within a memory subsystem of a computing system (step 402). The known memory location can be, for example, a particular memory address. The executable code generally represents code that may be the target of frequent calls from other code installed within the computing system.

In the example embodiment shown, the method 400 further includes establishing a jump table within the near address range (step 404). The jump table may be, for example, located near an outer bound of a “near” address range relative to the executable code. The method 400 also includes storing a workload in memory of the computing system (step 406). The workload includes one or more storable code segments, for example executable functions. In particular embodiments, the workload may be selected based on the fact that it calls the executable code at a high frequency, but may not be able to be stored in the “near” address range due to size/capacity constraints. In accordance with the present disclosure, the workload may instead be stored within a “close” address range relative to the executable code.

As referred to herein and noted above, “near” code refers to code that is within a direct call or jump from a particular address (in this case, an address of a called function in the executable code installed in step 402). For example, in certain instruction set architectures, a call instruction may exist that includes a 32 bit address incorporated within (e.g., within the instruction itself). Other instruction set architectures may use different numbers of bits for direct addresses of jump or call instructions.

As also noted above, the “close” code into which a workload may be stored may be distinguishable from “near” code, since it is outside of a directly addressable range from the particular address, but within a direct jump or call from a location within that “near” code range. Accordingly, an unconditional call or jump within the “close” code may access the jump table in near code by a further direct call or jump the instruction. Accordingly, “close” code is, in effect, two unconditional call or jump instructions away from the code to be called.

To accommodate the workload and the jump table, the workload installed at step 406 will be compiled to include unconditional call instructions that call entries in the jump table. The jump table entries, in turn, are unconditional call or jump instructions into frequently used functions included in the executable code, and installed at the particular memory address. Accordingly, rather than requiring an address of the function included in the executable code to be conditionally computed during execution of the workload (from an indirect call instruction), the workload may be translated for execution by including a direct address reference into the jump table to an entry that, in turn, is a direct call or jump instruction that references a core function included in the executable code. This avoids, or reduces, use of indirect call instructions to frequently-executed code.

By way of reference, code that is described in the present application as being installed in a “close” code location may, absent a jump table or other directly-addressable, direct-addressing redirection mechanism, be considered to be located in “far” memory. Calls from “far” memory generally would otherwise be required to use indirect call instructions, and would require various register loading, validation, and conditional assessment operations. Accordingly, significant additional overhead is required to execute such instructions. Additionally, because such indirect call instructions are conditional, some additional inefficiencies are introduced because a processor may not accurately predict whether the indirect call will be executed, and as such, CPU stall/pipeline flushes may occur. To avoid the inefficiencies of indirect call instructions, a chain of unconditional call or jump instructions is used instead.

In the example shown, the jump table may be organized in any of a number of ways. In general, and as discussed further below, jump table entries may contain an unconditional jump or branch instruction that references or includes an address of a particular function to be executed from the core executable code. Such jump table entries may be grouped based on type, or grouped based on those which are commonly executed. Jump table entries (e.g., non-conditional jump or branch instructions having a direct address included with the instruction) may be loaded into a cache of the microprocessor of the computing system in which they are used, and cache misses may be minimized due to such grouping. Other approaches are possible as well, as discussed below.

In the example shown, the method also includes executing the workload (step 408). Executing the workload may include, for example, executing a hosted workload that includes a plurality of functions, including at least one function within the close address space. Upon executing a workload from within the close address space, it is noted that the workload may call a function within the executable at the known address. Since such a call cannot be executed as a direct call (since the function is outside the address range accessible via a 32-bit addressable direct address offset), rather than using an instruction implementing an indirect addressing scheme, the call is executed by using two instructions—a call from the workload to a jump table within the near address space (step 410), followed by an unconditional jump instruction to the function included in the executable code at the known address (step 412). Upon completion of execution of the executable code, program flow may return to the workload (step 414).

Referring to FIG. 4 generally, this mechanism, using two unconditional jump/branch instructions, has been seen to provide a lower overall performance degradation as compared to use of an indirect call instruction for circumstances where such call instructions are executed frequently. For example, while a performance degradation between direct and indirect calls may be up to or in excess of a 10% performance degradation (as compared to use of a single direct addressing call instruction), in some cases, use of a direct addressing call instruction to a jump table and a direct, unconditional jump instruction from the jump table to the code to be executed may result in less performance degradation (e.g., 2-4% performance degradation). Accordingly, in hosted computing environments where hosting code is called frequently from workloads, significant performance degradation can be avoided, while allowing larger code bases to be stored in memory locations outside of the “near” code.

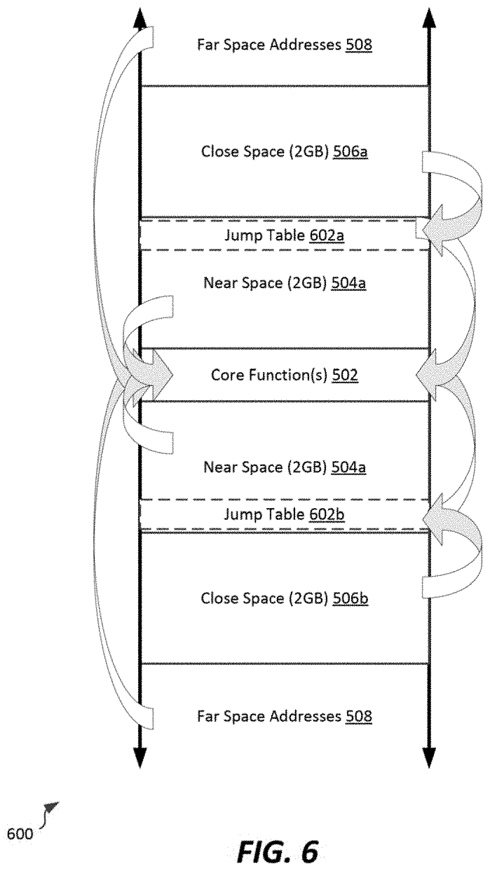

FIGS. 5-6 illustrates such a memory address range and the calls into executable code in accordance with the present disclosure. As seen in FIG. 5, an addressable memory subsystem 500 includes a known address at which core functions 502 may be stored. Proximate the known address, near space in memory extends to both sides of the installed core functions 502 (e.g., shown as 2 GB of memory space in near memory regions 504a-b, based on a 32-bit sign-extended address used in a near call instruction). Adjacent the near memory locations, close memory regions 506a-b can be found. In the example shown, the close memory regions also extend for 2 GB on either side of the core function(s) 502 adjacent the near memory regions 504a-b. Beyond the close memory regions, lie far space addresses 508.

As seen in FIG. 6, an illustration 600 of call and jump instructions within the memory subsystem 500 is provided. The call and jump instructions (referred to generally as call instructions) that reference the core functions 502 may be executed differently depending on the location from which the call or jump occurs.

In the example shown, instructions residing in near space addresses 504a-b may execute a directly-addressable call instruction to call the core functions 502 of executable code. Additionally, instructions residing in far space addresses 508 may access the core functions 502 via an indirect call instruction. Such direct and indirect call instructions are reflected in the arrows along the left side of FIG. 6.

By way of contrast, instructions residing in “close” space addresses 506a-b may be unable to use a direct call instruction, and use of an indirect call instruction would lead to greater inefficiency. Accordingly, a call instruction is performed to access a jump table 602a-b located near the boundary of the near space 504a-b. Since the jump table 602a-b is located at a periphery of the near space, it may be accessed from addresses further away from the core functions 502 than may access the core functions directly. Additionally, the jump table 602a-b may store direct jump instructions to be performed, which allow a jump directly into desired core functions 502. Accordingly, a directly-addressable call followed by a direct jump instruction may allow calls that reside in close space addresses 506a-b to be performed without use of indirect addresses, thereby avoiding inefficiencies associated with such instructions.

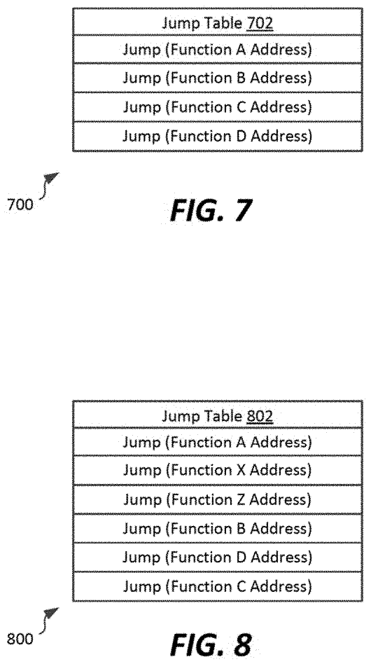

Referring to FIGS. 7-10, additional details are provided regarding the manner of organizing and using a jump table, such as jump tables 602a-b of FIG. 6. In the example seen in FIG. 7, an arrangement 700 showing a jump table 702 is illustrated in which a plurality of entries are provided. Each entry includes an unconditional call or jump instruction to a particular address in the core executable. The entries are arranged in order of appearance in an underlying program that may call the function via the jump table. In the example shown, each entry will be associated with a particular called function, and may include a jump address referencing an associated portion of executable code (e.g., within core functions 502) to be executed in response to a call to that function. In the example seen in FIG. 7, the entries in the jump table 702 are in order of appearance (e.g., the order in which they are called), and as such, the jump table 702 may be constructed prior to execution (e.g., based on previous inspection of code), for example at the time of storage of code in memory (creating jump table entries for each function that is called from the “close” memory space).

By way of contrast, an arrangement 800 of FIG. 8 illustrates a further example jump table 802. In this example, the jump table 802 may be reordered prior to execution. This may be based on an analysis of the functions that are called from the close memory space, such as a static analysis of functions to determine an appropriate ordering of functions within the jump table 802. In example embodiments, the ordering of functions may be based on similarity of the functions, since similar functions may be executed at a similar time and therefore the relevant portions of the jump table and/or executable code of the core functions 502 would be stored in the processor cache at the same time. Alternatively, functions may be included in the jump table based on frequency of expected use, e.g., in response to an ad-hoc analysis or based on sampling of actual execution statistics.

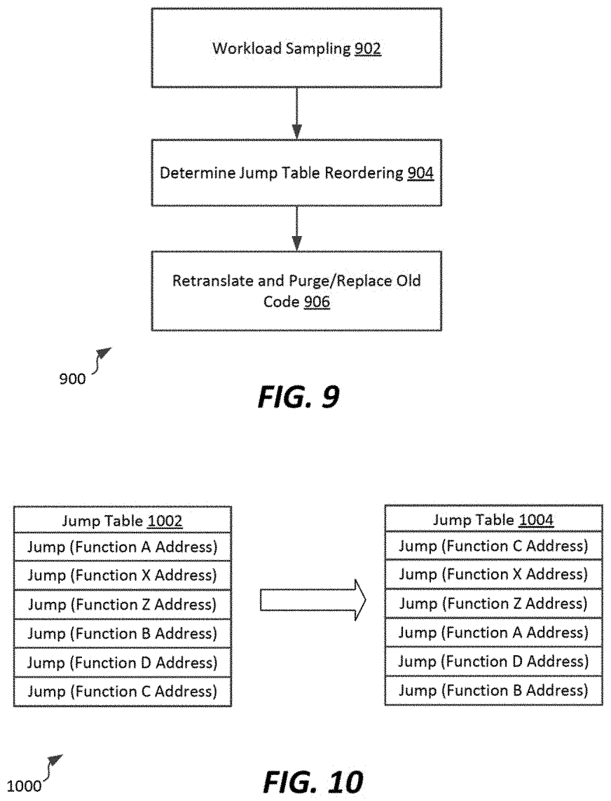

FIG. 9 illustrates an example approach of a method 900 for ordering a jump table in accordance with aspects of the present disclosure. The method 900 may be performed using the computing systems described above, and is used for improved performance of code in “close” address space relative to frequently-executed, core functions in code.

In the example shown, the method 900 can include performing a workload sampling during execution of the code (step 902). This may include storing a frequency of execution of particular functions within the workload, or ordering of execution of functions. The method further can include determining a jump table reordering (step 904). The jump table reordering may be accomplished in any of a number of ways. Upon determining a new jump table ordering, preexisting code may be purged, with new code and a new jump table installed, with the code being retranslated to use the new jump table (step 906). At that time, code execution may be resumed.

FIG. 10 is a schematic depiction of reordering of a jump table, according to the method of FIG. 9. In the example illustrated, an initial jump table 1002 may be migrated to a reordered jump table 1004. For example, the ordered entries in jump table 1002 (shown as jump instructions to functions A, X, Z, B, D, C, in order) may be reordered based on an analysis of those functions or the frequency of their use. As shown, the entries may be completely reordered in jump table 1004 which will replace jump table 1002 in memory, with the entries ordered such that, for example, (1) entries corresponding to more frequently used functions appear earlier in the jump table, and/or (2) entries corresponding to like functions are grouped, due to their likelihood of execution at the same or similar times. Such a replacement jump table may require recompilation of the workload to be executed to ensure proper resolution of call instructions into the jump table, and/or proper resolution of resulting jump instructions.

Referring to FIGS. 1-10 generally, it is noted that the present systems and methods have particular advantages in the context of hosted systems, such as virtualized systems that host execution of code that is written for use in a non-native instruction set architecture, or which is otherwise written such that a hosting application or executable is often called from the workload. In such cases, because of the frequency of calls to the hosting executable, substantial performance benefits may be realized by saving overhead by avoidance of indirect call or jump instructions in code that resides outside of near memory relative to the hosting executable. However, other scenarios may exist in which use of the principles described herein may be used outside of a virtualization or hosting context. For example, any circumstance in which frequent calls to a particular code segment from outside a directly addressable range may benefit from the techniques described herein, including not only implementing the jump table and associated direct-addressing instructions, but also the reordering of the jump table for further improved performance.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A method comprising:
instantiating executable code in a memory of a computing system, the executable code having a starting location in the memory;
implementing, within a near code area within the memory relative to the executable code, a jump table at a memory location proximate to a boundary of directly-addressable memory in the near code, the jump table including a plurality of entries each associated with one of a plurality of functions included in the executable code;
upon executing a call to one of the plurality of functions in the executable code from a workload:
executing a call instruction into the jump table from the workload, the call instruction including a direct address to a location in the jump table; and
executing the direct jump instruction from the jump table into the function.

2. The method of claim 1, wherein the executable code is directly executable by a processor of the computing system having a native instruction set architecture, and wherein the plurality of functions correspond to non-native instructions, and wherein the executable code comprises an instruction emulator configured to execute native instructions corresponding to each of the non-native instructions.

3. The method of claim 1, wherein the near code area comprises a memory location within an address distance of the executable code accessible via a directly-addressable call instruction in the instruction set architecture of the computing system.

4. The method of claim 1, further comprising:
sampling an executing workload on the computing system, the workload including calls to the plurality of functions;
determining a priority of the plurality of functions based at least in part on frequency of execution of the plurality of functions based on the sampling; and
reordering the jump table to prioritize frequently-used functions of the plurality of functions.

5. The method of claim 4, wherein reordering the jump table comprises ordering entries associated with the plurality of functions, at least in part, in descending order based on frequency of execution.

6. The method of claim 1, further comprising grouping entries in the jump table based on similarity of the functions associated with the entries.

7. The method of claim 1, wherein a processor of the computing system executes the call instruction and the direct jump instruction without experiencing a stall.

8. The method of claim 1, wherein the memory has an addressable size that is greater than an addressable range of the call instruction.

9. The method of claim 1, wherein the call instruction and the direct jump instruction are both unconditional instructions.

10. The method of claim 1, wherein the call instruction includes a 32-bit direct address.

11. A method of executing a hosted workload executable according to a non-native instruction set architecture on a computing system having a memory and a processor implemented using a native instruction set architecture, the method comprising:
instantiating a core emulation executable at a location in memory of the computing system, the core emulation executable including a plurality of functions;
placing a jump table in memory at a location from which the core emulation executable may be reached via a direct jump instruction in the native instruction set architecture, each of a plurality of entries in the jump table including a direct jump instruction to a different one of the plurality of functions;
executing a hosted workload from the memory of the computing system, the hosted workload being located, at least in part, in code outside of a region in memory from which the core emulation executable may be reached via a direct call instruction;
upon executing a call from the workload to a function included in the plurality of functions of the core emulation executable:
performing a directly-addressable call instruction to access the jump table; and
performing a direct jump instruction from the jump table to the function within the core emulation executable.

12. The method of claim 11, wherein the hosted workload comprises a compiled executable that includes a plurality of calls to the core emulation executable to perform emulated versions of non-native instructions.

13. The method of claim 11, further comprising:
analyzing the hosted workload to identify a plurality of functions called by the hosted workload; and
grouping entries associated with at least some of the plurality of functions within the jump table based on similarity.

14. The method of claim 11, further comprising:
sampling execution of the hosted workload to determine frequency of execution of each of the plurality of functions; and
ordering entries in the jump table at least in part based on frequency of execution of the plurality of functions corresponding to the entries.

15. The method of claim 11, wherein the direct jump instruction has an addressable range that is smaller than a distance between a core function at the address of the direct jump instruction and a portion of the hosted workload from which the direct jump instruction is called.

16. The method of claim 11, wherein the directly-addressable call instruction includes a 32-bit direct address.

17. The method of claim 11, wherein a processor of the computing system executes the call instruction and the direct jump instruction without experiencing a stall.

18. A computing system comprising:
a processor capable of executing instructions according to a native instruction set architecture;
a memory communicatively connected to the processor, the memory storing instructions which, when executed by the processor, cause the computing system to perform:
instantiating a core emulation executable at a location in memory of the computing system, the core emulation executable including a plurality of functions;
placing a jump table in memory at a location from which the core emulation executable may be reached via a direct jump instruction in the native instruction set architecture, each of a plurality of entries in the jump table including a direct jump instruction to a different one of the plurality of functions;
executing a hosted workload from the memory of the computing system, the hosted workload located at least in part in code outside of a region in memory from which the core emulation executable may be reached via a direct call instruction; and
upon executing a call from the workload to a function included in the plurality of functions of the core emulation executable:
performing a directly-addressable call instruction to access the jump table; and
performing a direct jump instruction from the jump table to the function within the core emulation executable.

19. The computing system of claim 18, wherein the computing system is implemented using an x86-based instruction set architecture.

20. The computing system of claim 19, wherein the hosted workload is implemented using a non-native instruction set architecture different from the native instruction set architecture.
